(19) United States
(12) Patent Application Publication
(10) Pub. No.: US 2016/0091243 A1
(43) Pub. Date: Mar. 31, 2016

(54) DOMESTIC APPLIANCE COMPRISING TWO OR MORE APPLIANCE UNITS

(71) Applicant: Miele & Cie. KG, Guetersloh (DE)

(72) Inventor: Dominic Beier, Guetersloh (DE)

(21) Appl. No.: 14/841,755

(22) Filed: Sep. 1, 2015

(30) Foreign Application Priority Data
Sep. 30, 2014 (DE) 10 2014 114 177.6

(51) Int. Cl. F25D 23/02; E05F 15/70; F25D 29/00; E05D 7/00

(52) U.S. Cl. CPC F25D 23/028; E05D 7/00; E05F 15/70; F25D 29/005; F25D 2600/00; F25D 2700/02

(57) ABSTRACT

A domestic appliance includes two or more appliance units, each having separate doors that operate independently of one another, the doors of the two or more appliance units each having an actuatable door opening mechanism. A control device is connected to the actuatable door opening mechanism of each door. A knock sensor is connected to the control device and coupled to a door of one of the two or more appliance units such that signals can be transmitted therebetween. The control device permits a door opening process to be activated selectively for each separate door of the two or more appliance units as a result of manually initiated knock signals on the door coupled to the knock sensor by comparing the manually initiated knock signals with predetermined knock signals associated with a certain door in each case.

### CROSS-REFERENCE TO PRIOR APPLICATION

Priority is claimed to German Patent Application No. DE 10 2014 114 177.6, filed on Sep. 30, 2014, the entire disclosure of which is hereby incorporated by reference herein.

### FIELD

The invention relates to a domestic appliance comprising two or more appliance units, each having separate doors to be operated independently of one another.

### BACKGROUND

Any appliances which are used as washing treatment appliances, cleaning appliances, cooking appliances, baking appliances and cooling appliances within the household are possible domestic appliances within the meaning of the present invention. These appliances are often used as fully integrated appliances built into kitchen fittings, wherein, for aesthetic reasons, a handle on the front of the appliance door which is cladded to look like the fittings is dispensed with. Therefore, in these appliances it is in particular desirable to provide a door opening mechanism which initiates the door opening process for example by means of an electrically operable actuator. EP 2 020 579 A2 for example proposes some alternative door operating apparatuses for a fridge freezer intended for the abovementioned use.

Furthermore, EP 2 497 405 A2, inter alia, discloses initiating an automatic opening process in a domestic appliance by means of a knock sensor. By manually knocking on the appliance door, the user can trigger knock signals which activate the door opening mechanism by means of a control device having a corresponding design.

Domestic appliances of the aforementioned type are often also combined in a combination of two or even more appliance units, each having separate doors which are to be manually operated independently of one another. The individual appliance units may be arranged one above the other or side by side in this case.

### SUMMARY

A domestic appliance includes two or more appliance units, each having separate doors that operate independently of one another, the doors of the appliance units each having an actuatable door opening mechanism. A control device is connected to the actuatable door opening mechanism of each door. A knock sensor is connected to the control device and coupled to the door of a first appliance unit of the appliance units such that signals can be transmitted therebetween. The control device permits a door opening process to be activated selectively for each door of the appliance units as a result of manually initiated knock signals on the door coupled to the knock sensor by comparing the manually initiated knock signals with predetermined knock signals associated with a respective door of the doors.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a front view of a fridge freezer combination with the doors open,

FIGS. 2 and 3 are each perspective views of the fridge freezer combination with the doors closed,

FIGS. 4 and 5 are each diagrams of knock signals, one showing two knock signals within a certain unit of time and one showing three knock signals within a certain unit of time.

### DETAILED DESCRIPTION

The invention can be implemented in any domestic appliance in which two or even more appliance units are combined and which each have separate doors which can be operated independently of one another. The individual appliance units may be arranged one above the other or side by side in this case.

According to the invention, the doors of the appliance units are equipped with an actuatable door opening mechanism which is connected to a control device of the domestic appliance such that it can be controlled thereby. A knock sensor is coupled to the door of a preferably selected appliance unit such that signals can be transmitted therebetween, the signals of said sensor being passed to the control device. The control device is designed having an evaluation unit such that, by manually knocking on said one selected appliance door, the door opening process can be activated selectively for each individual appliance door of the combined domestic appliance.

Which of the doors is intended to be opened is determined by a predetermined signal sequence of the triggered knock signals and a corresponding assignment to the respective appliance door.

A predetermined number of knock signals within a predetermined period of time can preferably establish and differentiate between which of the doors is intended to be opened. Alternatively, the frequency of the knock signals can also be used to trigger the door opening process in one of the appliance doors. In the process, the knock signals that occur within a predetermined period of time or at predetermined time intervals are determined and assigned to a certain appliance door.

The control device of the appliance combination is expediently designed such that a single, potentially unintentionally or accidentally triggered knock signal is disregarded. Therefore, only two knocks within a certain time frame are recognised as a door opening instruction for a predetermined appliance door and the corresponding door opening mechanism is activated. Three knocks within a certain time frame are then assigned to an additional door for the door opening process. By increasing the number of knock signals, even more doors of the appliance combination could also be opened automatically in this manner.

A particularly advantageous use is in a domestic appliance in the form of a cooling appliance combination having cooling appliances arranged one on top of the other. In cooling appliance combinations of this type, the bottom appliance is generally a freezer and the top appliance is generally a refrigerator. Both appliances each have doors to be opened separately. In said known cooling appliance combinations, the control unit for the two appliances is located in the upper region of the refrigerator.

For design reasons, the doors of said appliances are often covered with the decorative pattern of the fitted kitchen. Therefore, especially in this case there is the desire to provide an automatic door opening mechanism and to dispense with a handle for manual opening.

In this embodiment, the knock sensor connected to the control device is preferably coupled to the door of the refrigerator. By manually knocking on this door and by means of the knock signals triggered as a result, either the door of the refrigerator or the door of the freezer can be activated by the respective door opening mechanism. The signals emanating from the knock sensor are recognised by an evaluation unit of the appliance control device and compared with a predetermined signal sequence assigned to the respective appliance.

In a preferred embodiment, the control device of this cooling appliance combination is designed such that, by knocking twice on the top door, that of the refrigerator, the opening process of said door is initiated, while knocking on said door three times activates the door opening mechanism on the bottom door, that of the freezer.

One advantage of the abovementioned cooling appliance combination is that an electric cable can electrically connect the knock sensor and the control device, which cable can be guided through via the hinge hardware of the top appliance door and connected to the control device in the upper region of the refrigerator. This is advantageous in that no additional design complexity with regard to a new hinge is required for this purpose. Furthermore, with regard to the control, only one knock sensor is required to be able to actuate the respective door opening mechanism for the two doors. An electric cable connection between the control device and the door opening mechanism of the freezer can also be readily established inside the appliance body.

Overall, all the directional or positional information relates to position of the appliance or the appliance combination in which it is set up for operation.

In the appliance combination equipped according to the invention, the door opening mechanism for the individual doors can be designed such that both the entire opening process and the closing process are operated by an actuator system. It would also be sufficient for the actuator of the respective door opening device to produce just a single opening pulse at the door in order to overcome the closing force of the magnetic pull-open closure and the user manually performs the additional opening and closing process.

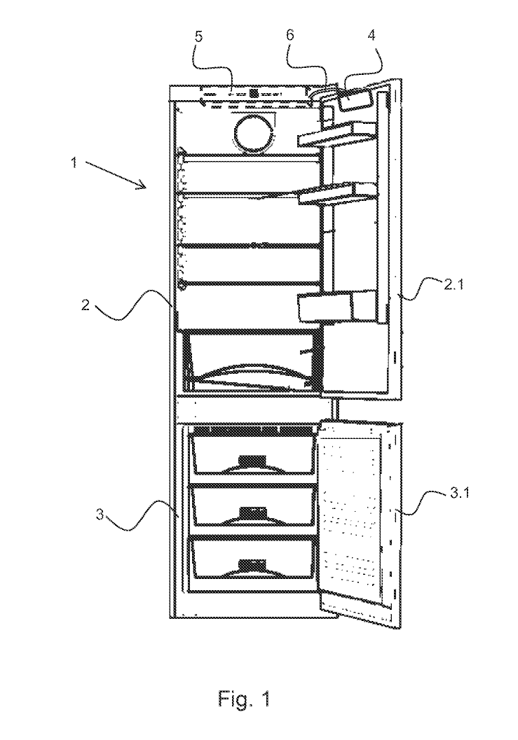

FIG. 1 shows a conventional fridge freezer combination 1. In this case, a freezer 3 and a refrigerator 2 are arranged one on top of the other.

In this figure, the door 2.1 of the refrigerator and the door 3.1 of the freezer are open.

A control device 5 for controlling the appliance functions is arranged in the upper region of the refrigerator 2. In the embodiment shown, a knock sensor 4 arranged in the door 2.1 of the refrigerator 2 is connected to the control device 5 by means of a cable connection 6. The electric cable is in this case guided through the upper hinge hardware of the refrigerator 2.

Both the door 2.1 of the refrigerator and the door 3.1 of the freezer are each formed having a controllable door opening mechanism. In this case, door opening mechanisms can be used which are known from the prior art but are not shown in detail in the drawings for reasons of clarity. The door opening mechanism may comprise suitable actuators which initiate the door opening process 2.2, 3.2 as a result of an instruction from the control device 5 of the appliance.

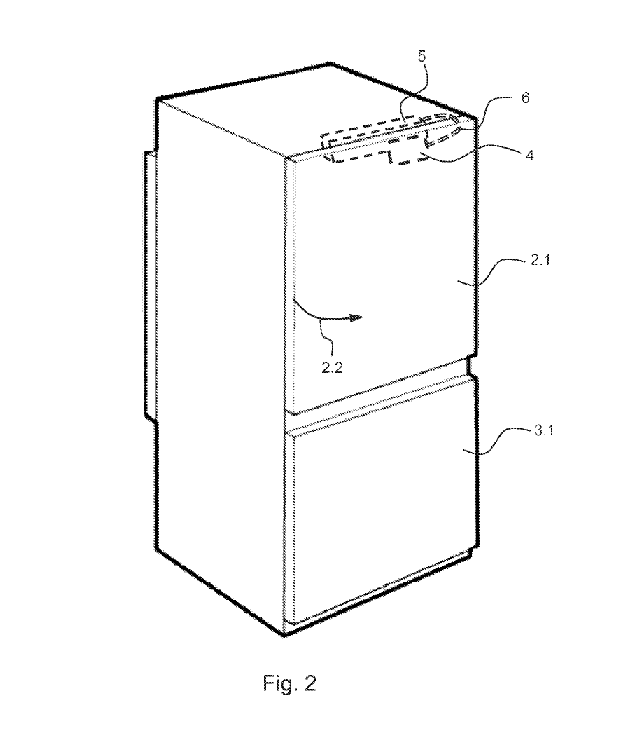

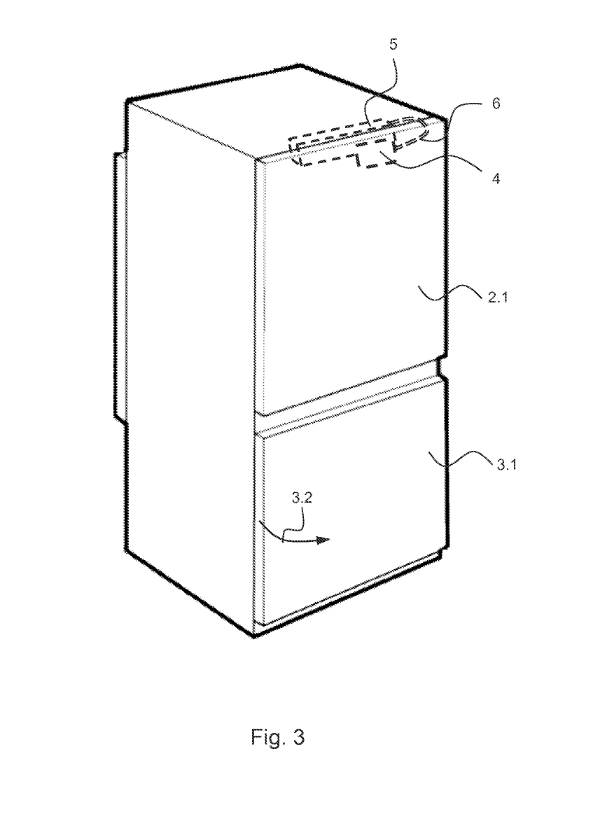

The mode of operation of the door opening mechanism for the two appliance doors 2.1 and 3.1 is explained in more detail below with reference to FIGS. 2 and 3.

If the user knocks on the door 2.1 of the refrigerator 2 twice within a predetermined time period, the knock signals generated by the knock sensor 4 are sent to the control device 5 in the upper region of the refrigerator. The door opening mechanism of the refrigerator door 2 is then activated by the control device 5 and causes the door 2.1 to pivot open 2.2 as a result (see FIG. 2).

In contrast, if the user wishes to open the door 3 of the freezer, he has to knock on the top door 2 of the cooling appliance combination three times, upon which the control device 5 triggers the door opening mechanism for the door 3.1 of the freezer 3 and starts or causes the pivot movement 3.2 (see FIG. 3).

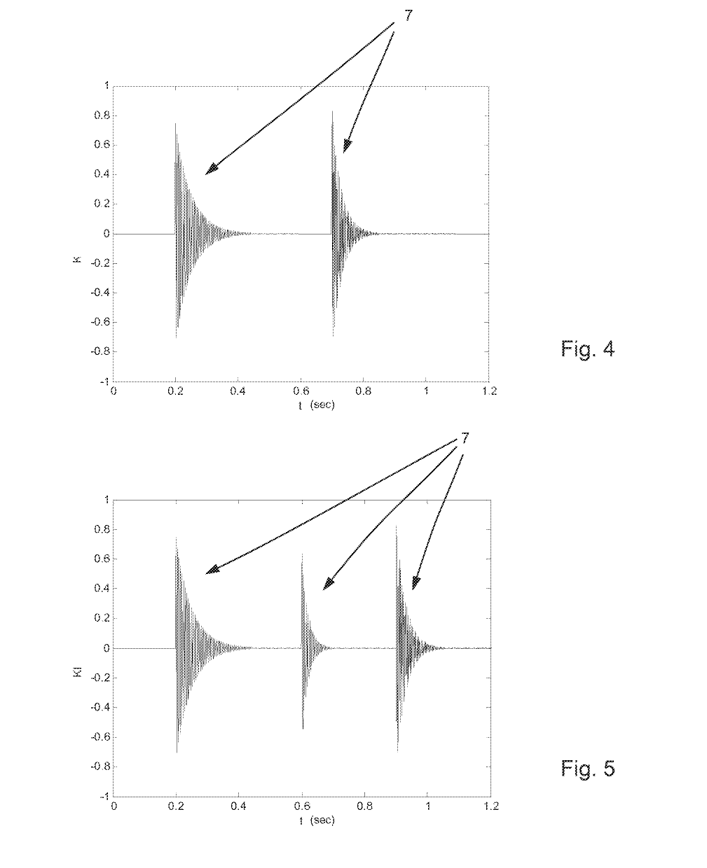

FIGS. 4 and 5 show a possible embodiment of distinctive knock signals, which can be assigned to one of the appliance doors in each case.

FIG. 4 shows two knock signals 7 which cause the door 2.1 of the refrigerator 2 to open, while the three knock signals 7 in FIG. 5 initiate the opening process for the door 3.1 of the freezer. In both cases it is provided that each of the knock signals 7 has to be provided within a predetermined time frame, within 1 to 2 seconds in this case, preferably 1.2 seconds, so that the control device 5 can recognise a clear and intentional opening instruction for a certain door.

In addition to the number of knock signals, other embodiments are also conceivable for evaluating knock signals. In this way, the frequency of the knock signals for example can be used, i.e. fast successive knocking is assigned to one door and slightly slower knocking is assigned to the other door.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1. fridge freezer combination

2. refrigerator
2.1 refrigerator door
2.2 door opening process

3. freezer
3.1 freezer door
3.2 door opening process

4. knock sensor

5. control device

6. cable

7. knock signal

What is claimed is:

1. A domestic appliance, comprising:
two or more appliance units, each having separate doors configured to be operated independently of one another, the doors of the appliance units each having an actuatable door opening mechanism;
a control device connected to the actuatable door opening mechanism of each door; and
a knock sensor connected to the control device and coupled to the door of a first appliance unit of the appliance units such that signals can be transmitted therebetween,
wherein the control device is configured such that a door opening process can be activated selectively for each door of the appliance units as a result of manually initiated knock signals on the door coupled to the knock sensor by comparing the manually initiated knock signals with predetermined knock signals associated with a respective door of the doors.

2. The domestic appliance of claim 1, wherein the control device is configured to recognise a predetermined number of manually initiated knock signals and to assign the predetermined number of manually initiated knock signals to the respective door in each case, and wherein the actuatable door opening mechanism of one of the doors is configured to be activated by the control device depending on the number of manually initiated knock signals detected.

3. The domestic appliance of claim 1, wherein the control device is configured to recognize manually initiated knock signals that occur within a predetermined period of time or at predetermined time intervals and to associate those manually initiated knock signals with the respective door, and wherein, depending thereon, is configured to activate the actuatable door opening mechanism of the respective assigned door.

4. The domestic appliance of claim 1, wherein the domestic appliance comprises a cooling appliance combination having cooling appliances arranged one on top of the other.

5. The domestic appliance of claim 1, wherein the cooling appliances comprise a refrigerator arranged on top of a freezer, wherein the knock sensor is coupled to the door of the refrigerator and configured such that signals can be transmitted therebetween so that either the door of the refrigerator or the door of the freezer can be activated by the respective actuatable door opening mechanism as a result of manually initiated knock signals on the door of the refrigerator by comparing the manually initiated knock signals with predetermined knock signals.

6. The domestic appliance of claim 5, wherein the control device of the cooling appliance combination is configured such that, as a result of a number of knock signals triggered within a predetermined period of time by manually knocking on the door of the refrigerator, the control devices determines whether to activate the actuatable door opening mechanism of the door of the refrigerator or of the door of the freezer.

7. The domestic appliance of claim 6, wherein the control device is configured to trigger the actuatable door opening mechanism of the door of the refrigerator by knocking twice on the door of the refrigerator and by the knock signals triggered thereby within a predetermined period of time, and to trigger the actuatable door opening mechanism of the door of the freezer by knocking on the door of the refrigerator three times and by the knock signals triggered thereby within a predetermined period of time.

8. The domestic appliance of claim 5, wherein the control device is arranged in a housing of the refrigerator.

9. The domestic appliance of claim 8, further comprising an electric cable that electrically connects the knock sensor and the control device and is guided in the refrigerator via hinge hardware of the door of the refrigerator to the control device, wherein an electrical connection between the control device and the actuatable door opening mechanism of the freezer is established by a cable laid inside a body of the freezer.
